(19) United States
(12) Patent Application Publication
(10) Pub. No.: US 2020/0401396 A1
(43) Pub. Date: Dec. 24, 2020

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Yonghwi OH, Hwaseong-si (KR)

(73) Assignees: HYUNDAI MOTOR COMPANY, Seoul (KR); KIA MOTORS CORPORATION, Seoul (KR)

(21) Appl. No.: 16/684,138

(22) Filed: Nov. 14, 2019

(30) Foreign Application Priority Data
Jun. 20, 2019 (KR) 10-2019-0073572

(51) Int. Cl. G06F 8/658; B60R 16/023; H04L 5/00; H04W 4/40

(52) U.S. Cl. CPC G06F 8/658; H04W 4/40; H04L 5/005; B60R 16/023

(57) ABSTRACT

A method of controlling a vehicle includes: receiving, by an electronic control unit (ECU) manager, first update data in response to an update request signal of the vehicle; obtaining channel information of an ECU connected to the ECU manager; obtaining interference data corresponding to the channel information; generating correction data based on the channel information and the interference data; and generating second update data based on the correction data and the first update data; and performing over-the-air (OTA) update of the vehicle based on the second update data.

### CROSS-REFERENCE TO RELATED APPLICATION

This application claims priority to and the benefit of Korean Patent Application No. 10-2019-0073572, filed on Jun. 20, 2019, the entire contents of which are incorporated herein by reference.

### FIELD

Embodiments of the disclosure relate to a vehicle and a method of controlling the vehicle, and more particularly, to a software wireless update of the vehicle.

### BACKGROUND

The statements in this section merely provide background information related to the present disclosure and may not constitute prior art.

As an electronic control technology has developed, various electronic control technologies have been applied to vehicles. The vehicle is equipped with a number of electronic control units (ECUs) to implement the electronic control technology, and the vehicle may perform electronic control by the ECUs.

On the other hand, the vehicle requires separate software (or firmware) to operate the ECUs. The software needs to be improved as desired, and the vehicle may perform an update to improve existing software.

In the past, a software update was performed by a wired method such as using a storage storing update data for the vehicle. Recently, however, a wireless communication network method is adopted rather than a wired method. Thus, receiving the update data from an external server is referred to as over-the-air (OTA) update.

In addition to communication with the outside, the vehicle may perform wireless communication between various electronic devices therein. We have discovered that there is a problem that the vehicle is prevented from performing the OTA update due to an internal interference signal.

### SUMMARY

The present disclosure provides a vehicle capable of performing over-the-air (OTA) update that is not affected by interference signals inside the vehicle, and a method of controlling the vehicle.

Additional aspects of the disclosure will be set forth in part in the description which follows and, in part, will be obvious from the description, or may be learned by practice of the disclosure.

In accordance with an aspect of the disclosure, a method of controlling a vehicle includes: receiving, by an electronic control unit (ECU) manager, first update data in response to an update request signal of the vehicle; obtaining channel information of an ECU connected to the ECU manager; obtaining interference data corresponding to the channel information; generating correction data based on the channel information and the interference data; and generating second update data based on the correction data and the first update data, and performing over-the-air (OTA) update of the vehicle based on the second update data.

The obtaining of the channel information may include receiving, by the ECU manager, a first pilot signal from the ECU; transmitting a second pilot signal to the ECU in response to the first pilot signal; and obtaining, by the ECU, the channel information identified by comparing the first pilot signal with the second pilot signal.

The obtaining of the channel information may include obtaining a plurality of channel information among a plurality of ECUs connected to the ECU manager.

The obtaining of the interference data may include obtaining first interference data corresponding to first channel information and second interference data corresponding to second channel information among the plurality of channel information.

The channel information and the interference data may be obtained through a cable connected between the ECU manager and the ECU.

The receiving of the first update data may include receiving the first update data from a server providing the OTA update.

The receiving of the first update data may include receiving the first update data from an external terminal in which data related to the OTA update is stored.

The performing of the OTA update of the vehicle may include removing, by the ECU manager, noise added to the first update data based on the correction data; and generating the second update data.

In accordance with another aspect of the disclosure, a vehicle includes: an electronic control unit (ECU) including at least one memory and configured to execute software stored in the memory; and an ECU manager connected to the ECU and configured to provide the ECU with update data for updating the software. The ECU manager may receive first update data in response to an update request signal, obtain channel information from the ECU; obtain interference data corresponding to the channel information, generate correction data based on the channel information and the interference data, generate second update data based on the correction data and the first update data, and control the ECU to perform over-the-air (OTA) update of the vehicle based on the second update data.

The ECU manager may receive a first pilot signal from the ECU, transmit a second pilot signal to the ECU in response to the reception of the first pilot signal, and obtain the channel information identified by comparing the first pilot signal with the second pilot signal by the ECU.

The ECU manager is connected to a plurality of ECUs, and may obtain a plurality of channel information from the plurality of ECUs connected to the ECU manager.

The ECU manager may obtain first interference data corresponding to first channel information and second interference data corresponding to second channel information among the plurality of channel information.

The ECU manager may obtain the channel information and the interference data through a cable connected between the ECU manager and the ECU.

The ECU manager may receive the first update data from a server providing the OTA update.

The ECU manager may receive the first update data from an external terminal in which data related to the OTA update is stored.

The ECU manager may remove noise added to the first update data based on the correction data, and to generate the second update data.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a network system between a server in which an over-the-air (OTA) update system is implemented and a vehicle;

FIG. 2 is a control block diagram of a server and a vehicle;

FIG. 3 is a flowchart illustrating a control method; and

FIG. 4 is a control flowchart illustrating a control method.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Not all elements of embodiments of the disclosure will be described, and description of what are commonly known in the art or what overlap each other in the embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

Further, when it is stated that a layer is “on” another layer or substrate, the layer may be directly on another layer or substrate or a third layer may be disposed there between.

It will be understood that, although the terms first, second, third, etc., may be used herein to describe various elements, it should not be limited by these terms. These terms are only used to distinguish one element from another element.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. The terms may refer to an electrical circuit, and may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, the operation principles and embodiments of the disclosure will be described with reference to the accompanying drawings.

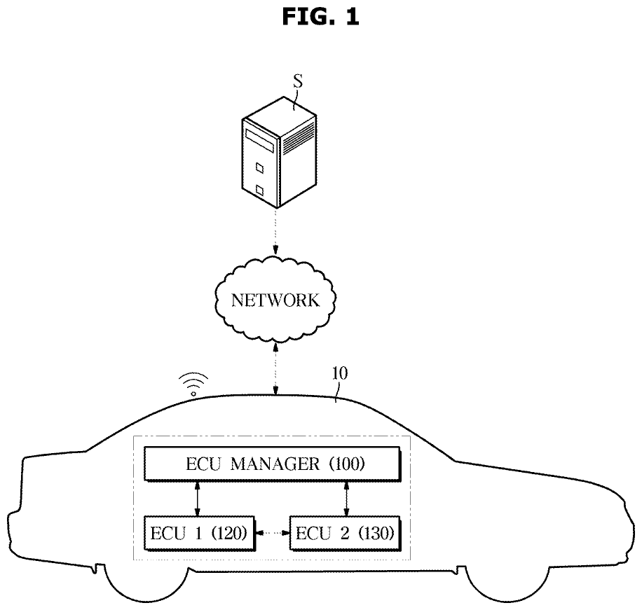

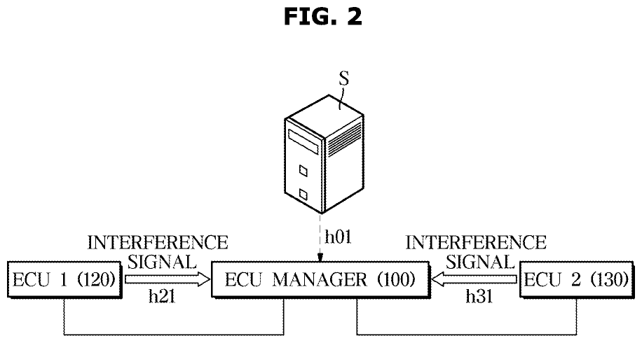

FIG. 1 is a view illustrating a network system between a server in which an over-the-air (OTA) update system is implemented and a vehicle, and FIG. 2 is a control block diagram of a server and a vehicle.

A network system may include a server S configured to provide update data, an electronic control unit (ECU) manager 100 configured to receive the update data, an ECU 1 120 and an ECU 2 130 connected to the ECU manager 100. Here, although two ECUs are illustrated for convenience of description, it is a matter of course that the ECU may be composed of a plurality of ECUs for various controls performed in a vehicle 10.

The server S may provide the update data for updating software installed in various devices of the vehicle 10. At this time, the server S may adopt the over-the-air (OTA) scheme and provide the update data to the vehicle 10 through wireless communication in accordance with a predetermined cycle or a setting of a server administrator.

The vehicle 10 may include the ECU manager 100, the ECU 1 120, and the ECU 2 130 that receive the update data from the server S. The ECU manager 100 may collectively manage the ECU 1 120 and the ECU 2 130 and may be wired or wirelessly connected to perform a software update for each. Accordingly, the ECU manager 100 may provide the update data received from the server S to the ECU 1 120 or the ECU 2 130. The ECU 1 120 may include various software for controlling various devices mounted on the vehicle 10.

The ECU 1 120 and the ECU 2 130 may be processors for controlling one of various devices mounted in the vehicle 10, or may be processors for controlling different independent devices. At this time, the ECU 1 120 and the ECU 2 130 may be connected to the ECU manager 100 and at the same time may be connected by wire or wirelessly to exchange or unilaterally provide control signals to each other.

The ECU manager 100 is a processor that controls various operations of receiving data for updating software, and may include at least one memory (not illustrated) in which programs for managing the ECU 1 120 and the ECU 2 130 are stored. It may include at least one processor for executing the stored programs.

The ECU 1 120 and the ECU 2 130 may include at least one memory (not illustrated) in which software for controlling the operation of at least one device is stored and at least one processor executing the stored software. In addition, the ECU 1 120 and the ECU 2 130 may receive software data or software update data from the ECU manager 100.

It may be an already mounted processor for controlling at least one device, or may be the processor provided separately from an already mounted processor.

As illustrated in FIG. 2, the ECU manager 100 may be interfered with data received from the server S by a radio signal generated by the ECU 1 120 or the ECU 2 130.

For example, the ECU manager 100 may be affected by an interference signal in a process of receiving a data signal of channel information h01 from the server S. The interference signal may refer to a signal that may affect a device other than a control object as a noise generated due to wireless communication inside the vehicle 10. The interference signal may be a radio interference signal of which channel information generated by the ECU 1 120 is h21 or a radio interference signal of which channel information generated by the ECU 2 130 of h31.

The ECU manager 100 may be affected by the radio interference signal of which channel information generated from the ECU 1 120 is h21 during an operation of the ECU 1 120. For example, when the data to be received by the ECU manager 100 is X and the radio interference signal generated by the ECU 1 120 is A, the vehicle 10 may receive data including noise that is X+A due to the influence of the ECU 1 120. Therefore, the vehicle 10 needs to remove and receive the radio interference signal that acts as the noise. At this time, the ECU manager 100 needs to obtain h21, which is channel information as a condition for removing the radio interference signal corresponding to the noise. The process of obtaining the channel information will be described in detail below.

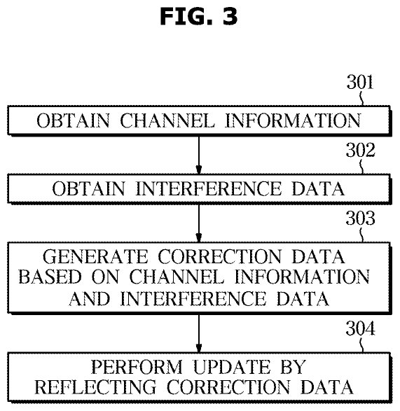

FIG. 3 is a flowchart illustrating a control method according to embodiments of the disclosure. However, this is merely exemplary and it should be understood that some of the operations may be added or omitted if desired.

The ECU manager 100 may obtain channel information of at least one ECU (301). At this time, the ECU manager 100 may receive first update data and obtain channel information in response to an update request signal of the vehicle 10. Here, the first update data may indicate update data for which noise is not removed by the ECU.

The ECU manager 100 may obtain interference data corresponding to the channel information (302). Here, the interference data may refer to the radio interference signal generated by the ECU, and may refer to noise that prevents the ECU manager 100 from receiving correct update data.

The ECU manager 100 may generate correction data based on the channel information and the interference data (303). The ECU manager 100 may generate the correction data to remove noise component included in the first update data. The ECU manager 100 may remove the noise component included in the first update data when it knows the channel information of the radio interference signal and data component of the radio interference signal generated in the vehicle 10. In conclusion, the correction data is for generating second update data included in the first update data.

The first update data may be received from the server S providing an OTA update, or may be received from an external terminal possessed by a user. For example, the external terminal may be a notebook, a laptop and a smart phone.

Finally, the ECU manager 100 may perform the update based on the correction data generated in operation 303 (304). In detail, the ECU manager 100 may perform the update using the second update data that reflects the correction data in the first update data and participates only in the software update.

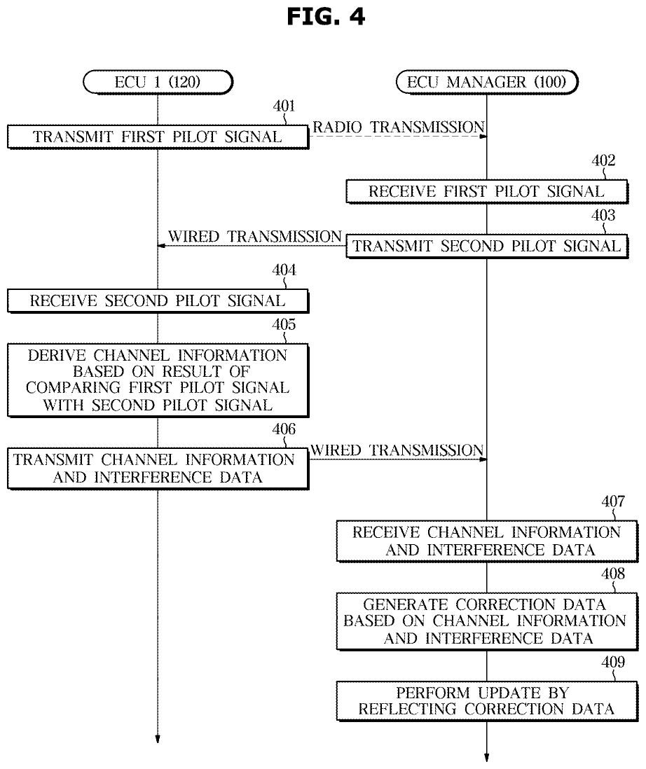

FIG. 4 is a control flowchart illustrating a control method according to embodiments of the disclosure. However, this is merely exemplary and it should be understood that some of the operations may be added or omitted if desired.

In FIG. 4, the ECU 1 120 is illustrated as an example for convenience of description, but it is not necessarily performed by the ECU 1 120. Therefore, the control method according to FIG. 4 may be applied to a plurality of ECUs and the ECU manager 100. According to an embodiment, in the operation of obtaining the channel information, the ECU manager 100 may obtain a plurality of channel information among the plurality of ECUs. In this case, the ECU manager 100 may obtain a plurality of interference data corresponding to the plurality of channel information using the plurality of channel information, and may remove a complex radio interference signal generated from the plurality of ECUs.

A pilot signal referred to in the embodiment may refer to obtaining the channel information between a transmission side and a receiving side in wireless communication. For example, in the disclosure, the pilot signal may indicate that the ECU manager 100 determines which of the plurality of ECUs mounted on the vehicle 10 is the signal generated from the ECU.

The ECU 1 120 may transmit a first pilot signal to ECU manager 100, and the ECU manager 100 may receive the first pilot signal transmitted from ECU 1 120 (401, 402). At this time, the first pilot signal may indicate the signal wirelessly transmitted from the ECU 1.

The ECU manager 100 may transmit a second pilot signal to the ECU 1 120 in response to the reception of the first pilot signal, and the ECU 1 120 may receive the second pilot signal transmitted from the ECU manager 100. (403, 404). The second pilot signal may indicate the signal generated based on the pilot signal estimated to be transmitted by the ECU 1 120. In addition, the second pilot signal may indicate the signal transmitted from the ECU manager 100 by wire. As described above, the ECU manager 100 may be connected to the plurality of ECUs by cables and may perform wired communication.

When the exchange between the first pilot signal and the second pilot signal is completed in operations 401 to 404, the ECU 1 120 may derive the channel information based on a result of comparing the first pilot signal with the second pilot signal (405). At this time, the ECU 1 120 may provide its channel information to the ECU manager 100 when the first pilot signal transmitted wirelessly and the second pilot signal received by wire are the same.

Although the ECU 1 120 compares the first pilot signal with the second pilot signal and derives the channel information in operation 405, the ECU manager 100 may perform the process of comparison determination, and the ECU manager 100 may obtain the ECU 1 120 in a manner of requesting it.

When the channel information is derived, the ECU 1 120 may transmit the channel information and the interference data to the ECU manager 100, and the ECU manager 100 may receive the channel information and the interference data (406 and 407). The interference data is a radio control signal for controlling an electronic device mounted on the vehicle 10 by the ECU 1 120, but from the perspective of the ECU manager 100, the radio control signal generated by the ECU 1 120 is the radio interference signal.

The ECU manager 100 may generate the correction data based on the channel information and the interference data (408). The ECU manager 100 may generate the correction data to remove the noise component included in the first update data. The ECU manager 100 may remove the noise component included in the first update data when it knows the channel information of the radio interference signal and data component of the radio interference signal generated in the vehicle 10. In conclusion, the correction data is for generating second update data included in the first update data.

Finally, the ECU manager 100 may perform the update based on the correction data generated in operation 408 (409). In detail, the ECU manager 100 may perform the update using the second update data that reflects the correction data in the first update data and participates only in the software update.

According to an aspect of the disclosure as described above, by performing the OTA update reflecting the correction data for removing the interference signal inside the vehicle, it is possible to shorten an update time of the vehicle and increase the reliability of a received signal.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A method of controlling a vehicle comprising:
receiving, by an electronic control unit (ECU) manager, first update data in response to an update request signal of the vehicle;
obtaining channel information of an ECU connected to the ECU manager;
obtaining interference data corresponding to the channel information;
generating correction data based on the channel information and the interference data; and
generating second update data based on the correction data and the first update data, and performing over-the-air (OTA) update of the vehicle based on the second update data.

2. The method according to claim 1, wherein obtaining the channel information comprises:
receiving, by the ECU manager, a first pilot signal from the ECU;
transmitting a second pilot signal to the ECU in response to the first pilot signal; and
obtaining, by the ECU, the channel information identified by comparing the first pilot signal with the second pilot signal.

3. The method according to claim 1, wherein obtaining the channel information comprises:
obtaining a plurality of channel information among a plurality of ECUs connected to the ECU manager.

4. The method according to claim 3, wherein obtaining the interference data comprises:
obtaining first interference data corresponding to first channel information and second interference data corresponding to second channel information among the plurality of channel information.

5. The method according to claim 1, wherein the channel information and the interference data is configured to be obtained through a cable connected between the ECU manager and the ECU.

6. The method according to claim 1, wherein receiving the first update data comprises:
receiving the first update data from a server providing the OTA update.

7. The method according to claim 1, wherein receiving the first update data comprises:
receiving the first update data from an external terminal in which data related to the OTA update is stored.

8. The method according to claim 1, wherein performing the OTA update of the vehicle comprises:
removing, by the ECU manager, noise added to the first update data based on the correction data; and
generating the second update data.

9. A vehicle comprising:
an electronic control unit (ECU) including at least one memory and configured to execute software stored in the memory; and
an ECU manager connected to the ECU and configured to provide the ECU with update data for updating the software,
wherein the ECU manager is configured to:
receive first update data in response to an update request signal;
obtain channel information from the ECU;
obtain interference data corresponding to the channel information;
generate correction data based on the channel information and the interference data;
generate second update data based on the correction data and the first update data; and
control the ECU to perform over-the-air (OTA) update of the vehicle based on the second update data.

10. The vehicle according to claim 9, wherein the ECU manager is configured to:
receive a first pilot signal from the ECU;
transmit a second pilot signal to the ECU in response to the first pilot signal; and
obtain the channel information identified by comparing the first pilot signal with the second pilot signal by the ECU.

11. The vehicle according to claim 9, wherein the ECU manager is connected to a plurality of ECUs, and is configured to obtain a plurality of channel information from the plurality of ECUs connected to the ECU manager.

12. The vehicle according to claim 11, wherein the ECU manager is configured to obtain first interference data corresponding to first channel information and second interference data corresponding to second channel information among the plurality of channel information.

13. The vehicle according to claim 9, wherein the ECU manager is configured to obtain the channel information and the interference data through a cable connected between the ECU manager and the ECU.

14. The vehicle according to claim 9, wherein the ECU manager is configured to receive the first update data from a server providing the OTA update.

15. The vehicle according to claim 9, wherein the ECU manager is configured to receive the first update data from an external terminal in which data related to the OTA update is stored.

16. The vehicle according to claim 9, wherein the ECU manager is configured to remove noise added to the first update data based on the correction data, and to generate the second update data.
